(19) United States
(12) Patent Application Publication
(10) Pub. No.: US 2025/0381717 A1
(43) Pub. Date: Dec. 18, 2025

(54) COATED, MONOLAYER EXTRUDED BOPP FILM

(71) Applicant: Brückner Maschinenbau GmbH, Siegsdorf (DE)

(72) Inventors: Willi LINDEMANN, Bad Reichenhall (DE); Martin WOLF, Traunstein (DE); Alois KÖRBER, Reit im Winkl (DE)

(21) Appl. No.: 19/224,213

(22) Filed: May 30, 2025

(30) Foreign Application Priority Data
Jun. 13, 2024 (DE) 10 2024 116 608.8

(51) Int. Cl. B29C 48/00; B29C 37/00; B29C 48/08; B29C 48/40; B29C 48/80; B29C 48/885; B29K 23/00; B29K 105/00; C08J 7/04; C08J 7/12

(52) U.S. Cl. CPC B29C 48/0018; B29C 48/08; B29C 48/40; B29C 48/802; B29C 48/885; C08J 7/0423; C08J 7/123; B29C 37/0025; B29K 2023/12; B29K 2105/0088; B29K 2995/0018; B29K 2995/0053; B29K 2995/0097; C08J 2323/12; C08J 2323/26; C08J 2375/04

(57) ABSTRACT

A coated, biaxially oriented polypropylene film, a laminate material having the polypropylene film, and a method for producing the polypropylene film are disclosed. The polypropylene film is a monolayer extruded polypropylene film that includes an extruded polypropylene layer as well as at least one coating. The extruded polypropylene layer includes a homo polypropylene and a maleic anhydride grafted polypropylene. The coating is a dispersion coating comprising polyurethane.

### CROSS REFERENCE TO RELATED APPLICATION

This application claims priority to German Patent Application Number DE 10 2024 116 608.8, filed Jun. 13, 2024, the entire contents of which is hereby incorporated by reference.

### BACKGROUND

The disclosure relates to a coated, monolayer extruded BOPP (biaxially oriented polypropylene) film, a method for producing this polypropylene film as well as a laminate material comprising this polypropylene film.

A current trend in the plastics and packaging industry is plastic savings. In the case of sustainable packaging, the portion of polymeric constituents in packaging is to be reduced, in particular in packaging laminates. In addition to polymer films, typical packaging laminates comprise, for example, paper substrates and/or metal layers.

The reduction of the polymer film thickness is one option for reducing polymeric constituents. This makes sense not only economically as less raw materials need to be used but also satisfies environmental aspects. In addition, recycling of packaging laminates comprising a lower polymer content (for example, <5%) can be simplified as it is possible to stay under the valid foreign material limits. In this case, a reduction of the film thickness can also result in a further reduction of the overall thickness of the packaging laminate so that is possible to save on additional raw materials, such as a paper substrate.

For example, if a 15-μm-thick polymer film is used in a paper/polymer packaging laminate, the overall thickness of the packaging laminate must be at least 300 μm in order to fall under a foreign material limit of 5%. Each reduction of the polymer film thickness thus influences the overall thickness of the packaging laminate.

In addition, it is often necessary to use multi-layer extruded polymer films (multi-layer films) to attain the desired properties. The individual film layers (for example, 3-7 layers) can then be optimized for different properties. For example, the following properties can be set via corresponding film layers:
anti-block effect (mainly external layer),
sealing properties (mainly external layer),
optical properties, such as colour, gloss,
mechanical properties, such as tensile strength, shrinkage, . . . (primarily through internal layers and core layer), and adhesion improvement for further processing, metallization or lamination (external layer(s)).

The desired anti-block effect is usually attained through the addition of an AB master batch (AB=anti-block) or anti-block agents in the corresponding film layer (mainly external layers), such as known, for example, in the patent application DE 10 2018 101 747 A1: The anti-block agents typically comprise, among other things, solid particles with a size in the micrometre range (particle diameter of approx. 1 μm to 10 μm). The anti-block effect enables error-free and rapid winding and unwinding of the film. However, the AB master batches can impair other properties of the film, such as appearance and/or the metallizability.

It can also be necessary for the provision of sufficient barrier properties to metalize the polymer film. To this end, a copolymer that metalizes well is typically added to the external layer.

The individual film layers are typically made from different plastics and cannot be separated from each other. As a result, recycling is difficult or even impossible.

Following the trend in sustainable packaging, there have been tests to metalize the paper substrate directly. However, these tests have not resulted in the desired barrier quality. In addition, the obtained packaging laminates are uneconomical.

To produce thin films, it is also known from the field of technical BOPP films (e.g. capacitor films or current collector films) to force after extrusion what is termed a crystallite transformation of the polymer, in particular when stretching monolayer films. This crystallite transformation is achieved through the use of very pure and thus expensive materials and combined with slow cooling of the melt after extrusion.

As a result of the crystallite transformation, what are termed “lassos” are formed in the film that increase the roughness, thereby making it possible to avoid blocking of the film. However, slow cooling results in slow and often uneconomical production speeds. In addition, the rough surfaces impair the appearance and barrier effect of the film.

Furthermore, the raw materials for technical BOPP films (BOPP-C), such as capacitor films, must contain little or no phosphites in general due to the usual electrical property profiles. Thus, they are only stabilised slightly and can only be recycled with difficulty. BOPP raw materials that are used for packaging applications generally comprise a higher phosphite content. This phosphite content enables good recycling, in particular of production waste, such as edge strips, tears in the film or scrap offcuts.

In addition, BOPP-C raw materials are much purer and thus approximately 20-30% more expensive than packaging BOPP raw materials. The BOPP-C raw materials are consequently not used for packaging applications.

### SUMMARY

The disclosure encompasses eliminating the aforementioned disadvantages at least in part. In particular, a very thin polymer film is to be provided that comprises good optical quality and good barrier properties as well as a good metallizability. In addition, a laminate material is to be provided that has a low polymer content.

This is solved by means of a polymer film according to the disclosure, a production method as well as by means of a laminate material according to the disclosure. Further aspects of the disclosure are specified in the dependent claims and in the following description.

In particular, the is solved by means of a coated, biaxially oriented polypropylene film (BOPP film). The polypropylene film is a monolayer extruded polypropylene film that comprises an extruded polypropylene layer as well as at least one coating. The extruded polypropylene layer comprises a homo polypropylene and a maleic anhydride grafted polypropylene. The coating is a dispersion coating comprising polyurethane.

Polypropylene (abbreviated PP) is a partially crystalline, non-polar thermoplastic and is part of the family of polyolefins. Polypropylene is obtained via polymerisation of the monomer propylene. Polypropylene homopolymer (also: homo polypropylene, PPH) is a polypropylene that is obtained through the polymerisation of a pure propylene. For example, polypropylene homopolymer is sold by the company LyondellBasell under the trade names Moplen HP525J or Adstif HA622H. Moplen HP525J has a melt flow rate (MFR) of approximately 3.0 g/10 min and Adstif HA622H has, for example, a melt flow rate (MFR) of approximately 2.0 g/10 min.

In a further aspect, the polypropylene homopolymer can be an isotactic homo-polypropylene comprising a high degree of isotacticity; for example, the isotacticity of the homo polypropylene used can be in a range of more than 70% or in a range of more than 85% or in a range from 92 to 96%.

Maleic anhydride grafted polypropylene (PP-g-MAH) is a form of modified polypropylene that forms through the chemical bonding of maleic anhydride (MAH) to the polypropylene chain. This functionalisation changes the surface properties of the polypropylene. In particular, the compatibility with polar materials is improved. For example, maleic anhydride grafted polypropylene is sold by the company Mitsui Chemicals under the trade names ADMER™ (in particular ADMER™ AT1179E, ADMER™ AT3355E, ADMER™ RA206E, ADMER™ AT3177E, ADMER™ QF500E, or others), wherein ADMER™ AT1179E has proved to be particularly suitable. Further maleic anhydride grafted polypropylene materials are sold under the trade names Modic® (Mitsubishi Chemicals), Plexar® (Chemplex), Epilene® (Eastman) and Bynel® (DOW).

The blending of homo polypropylene and maleic anhydride grafted polypropylene surprisingly results in good coating adhesion so that no further adhesion promoters are required between the extruded polypropylene layer and the coating. Good adhesion is attributed to the polar components in the single-layer extruded polypropylene layer (monolayer).

If the polypropylene layer is only coated on one side, the printability can be improved on the second side of the polypropylene layer that is opposite the coating by means of the polar components. In addition, it has been shown that the adhesion of the polypropylene film on a structural layer (for example, a laminate material) can also be improved.

Furthermore, the coating comprising polyurethane results in the improvement of the barrier properties. Moreover, it has been shown that the metallizability of the polypropylene film is also improved through the coating. This enables the use of a (single-sided or double-sided) metalized film, for example as a packaging material (in particular as part of a laminate material with good barrier properties and/or good optical properties (gloss)), as a capacitor film (e.g. in a wound capacitor) or as a current collector film (e.g. in a battery).

As the coating is a dispersion coating, thus has not been extruded, very thin coating thicknesses can be achieved. In one aspect, the coating has a thickness in the range from 50 nm to 150 nm, or in the range from 80 nm to 120 nm, or in the range from 90 to 100nm. The coating is thus only a small portion of the overall thickness of the polypropylene film that, for example, in the range from 2 μm to 10 μm, or in the range from 3 μm to 7 μm, or in the range from 4 to 6 μm. Such thin films enable polymer to be saved and simultaneously increase the recyclability of laminate materials, as described initially.

The coating can be applied, for example, as a water-based polyurethane dispersion that contains, for example, the dispersed polyurethane known under the trade name TAKELAC™ WPB-341 (from Mitsui Chemicals).

In a further aspect, the coating comprises nanoparticles. For example, the coating can comprise nanoparticles of 2 wt % to 20 wt %, or 4% wt % to 15 wt %, or 5 wt % to 10 wt %. The nanoparticles can comprise, for example, SiO₂ nanoparticles (e.g. available under the trade name Levasil® CT4 PL), TiO₂ nanoparticles, Al₂O₃ nanoparticles, Fe₂O₃ nanoparticles, Fe₃O₄ nanoparticles, ZnO nanoparticles, and/or suchlike.

Moreover, the nanoparticles can have a mean particle diameter (equivalent sieve diameter) in the range from 20 nm to 150 nm, or in the range from 50 nm to 120 nm, or in the range from 80 to 100 nm. It shows that this particle size results in a surface whose roughness is sufficient to prevent blocking of the polypropylene film when winding and unwinding. In particular, it has shown that a coefficient of friction (COF value (us), ISO 8295) of the produced film of COF≤1 enables winding and unwinding of the film without any blocking. In particular, when winding the polypropylene film, a small amount of air can come between the individual wound layers and be held there so that error-free unwinding of the polypropylene film is then possible. Consequently, it is possible to dispense with anti-block master batches. In particular, the polypropylene film is free of anti-block master batches and, in particular, anti-block particles whose diameter are in the size range of the film thickness.

Dispensing with the anti-block master batches is advantageous as the nanoparticles can be chosen to be smaller (particle size as indicated above) than the anti-block particles typically used in the coextrusion of anti-block master batches. This is possible as the coating of the film is considerably thinner than conventional coextruded skin layers.

In addition, the roughness is small enough to obtain an optically high-value polypropylene film (with very low haze values) and/or good barrier properties (also combined with metallization). Even the metallization and the quality of a metallization can be improved through the coating, in particular through the use of nanoparticles in contrast to coextruded anti-block particles.

In addition, it has been shown that the nanoparticles (in contrast to anti-block agents or particles) do not damage the metalized polypropylene film when being wound and unwound. In particular, the occurrence of pinholes can be avoided that occur when the relatively large solid particles of known anti-block agents press into a metal layer when winding the film.

In another aspect, the extruded polypropylene layer (monolayer) is made of homo polypropylene and maleic anhydride grafted polypropylene.

The content of maleic anhydride grafted polypropylene in the extruded polypropylene layer can be at least 10 wt %, or at least 15 wt %, or at least 20 wt %. Furthermore, the content of maleic anhydride grafted polypropylene in the extruded polypropylene layer can be 35 wt % at the most, or 30 wt % at the most, or 25 wt % at the most.

It has been shown that the combination of maleic anhydride grafted polypropylene and homo polypropylene enables high production speeds even in the production of a single-layer extruded polypropylene layer (monolayer). Slow cooling of the extruded melt—as in the case of producing films with crystallite transformation—is not necessary. Thus, the polypropylene film, despite high production speeds, can have a thickness in the range from 2 μm to 10 μm, or in the range from 3 μm to 7 μm, or in the range from 4 to 6 μm. In addition, the polypropylene film can have a density in the range from 0.9 g/cm³ to 0.95 g/cm³, particularly in the range from 0.91 g/cm³ to 0.93 g/cm³.

Furthermore, it shows that the polypropylene film can be produced with very minor deviations in thickness. Consequently, capacitor films, current collector films and/or packaging films (or packaging laminates) can be produced. The thickness of the polypropylene film can be (over a production length of 100 m), for example, in a tolerance range of desired film thickness±0.4 μm, or in a tolerance range of desired film thickness±0.25 μm, or in a tolerance range of desired film thickness±0.12 μm.

Furthermore, the coating can be based on an aqueous or a substantially aqueous dispersion coating. A substantially aqueous dispersion coating can comprise (during application) a solvent content of max. 5 vol %.

Aqueous or substantially aqueous dispersion coatings enable the saving of solvent and improves explosion protection. For example, the coating can comprise TAKELAC™ WPB-341 (PU) from Mitsui Chemical.

In a further aspect, a metallization layer can be arranged above the coating (in particular in direct contact with the coating). The metallization can be arranged, as well as the coating, on one side or both sides of the polypropylene film.

The metallization layer can comprise aluminium, zinc, titanium, gold, silver, silicon, copper, chromium and/or other metals as well as their alloys or be made of these. Similarly, the metallization layer can comprise oxides of the aforementioned substances, in particular aluminium oxide (AlOₓ) and/or silicon oxide (SiOₓ), or be made of these. In particular, the metallization layer can comprise several (different) metallization layers. For packaging, it has been shown that good barrier properties can be attained with aluminium or aluminium alloys. In particular, a good moisture barrier can thus be achieved.

In an exemplary polypropylene film, the coating is arranged on the first side of the polypropylene layer. The second opposing side of the polypropylene layer is not coated, but surface treated. The surface treatment can be, for example, a corona and/or plasma surface treatment. As a result, the adhesion of the polypropylene film to the structural layers (e.g. a paper substrate) can be improved. Similarly, printability can be improved. Similarly, it is possible to treat the surface of the polypropylene film before coating (e.g. using plasma or corona).

Moreover, this is also solved by means of laminate material, in particular a food packaging laminate material. The laminate material comprises at least a polypropylene film of the kind described above as well as a structural layer, wherein the polypropylene film is arranged, in particular laminated, (directly) on the structural layer. The structural layer can comprise a paper substrate or be made of a paper substrate.

If a metallization layer is arranged on the polypropylene film, the metallization layer can face in the direction of the structural layer (the metallization layer is arranged between the coating and the structural layer). Alternatively, the polypropylene film can be arranged in such a way on the structural layer that the metallization layer faces outwards.

To improve recyclability, the content of polypropylene film in the laminate material can be 5 wt % at the most, or 4 wt % at the most or 3 wt % at the most. The low polymer content also saves resources.

The disclosure encompasses a method for producing a monolayer extruded polypropylene film of the kind described above. The method comprises the following steps:
extrusion of a polypropylene layer (monolayer), wherein the extruded polypropylene layer comprises a homo polypropylene and a maleic anhydride grafted polypropylene;
coating, in particular inline coating, of the extruded polypropylene layer with a coating, wherein the coating is applied as an aqueous dispersion and comprises polyurethane as well as optionally nanoparticles, and
stretching of the polypropylene layer. The stretching can comprise stretching of the polypropylene layer in the machine direction (by means of a MDO apparatus, machine direction orientation) and/or stretching in the transverse direction (by means of a TDO apparatus, transverse direction orientation).

In addition, the stretching in the machine direction and transverse direction can occur simultaneously or sequentially.

The coating can be applied after the stretching in the machine direction and transverse direction, i.e. on the already biaxially oriented polymer film. Similarly, it is possible to apply the coating before the stretching.

Moreover, it is possible to stretch the polymer film initially in one direction (e.g. in the machine direction, in a MDO apparatus). Subsequently, the coating can be applied to the polymer film that has been stretched in one direction (e.g. the machine direction). This coated polymer film can then be stretched in the second direction (e.g. the transverse direction, in a TDO apparatus). For example, the polymer film is stretched initially in the machine direction, then coated and subsequently stretched in the transverse direction.

Thus, the stretching can occur before and/or after the coating.

The extrusion occurs typically via a slot die of what is termed a chill roll. The extruded plastic melt or rather the extruded polypropylene layer can be guided over a chill roll before the stretching. Typically, the chill roll is produced from a heat-conducting material and is kept at a low temperature by means of internal cooling (often with water or another coolant). The temperature of the chill roll can be, for example, in a range from 35° C. to 45° C., or in a range from 38° C. to 42° C. By contacting the cooled surface of the roll, the plastic melt starts to solidify rapidly and hardens to a solid web.

To accelerate the cooling of the melt further, the plastic melt can be guided optionally through a water bath, wherein the water bath can have a temperature in the range from 20° C. to 35° C., or in the range from 22° C. to 28° C. High production speeds can thus be attained. The use of a water bath is not required for the production of PP films or coated PP films. However, it has been shown that a water bath can result in quicker and more homogeneous cooling.

The coating can occur by means of roller application, spray coating, curtain coating and/or suchlike. In particular, the coating can occur inline, thus in a stretching unit, in which the stretching also is carried out. In one aspect, the coating occurs by means of a reverse kiss coating method. Here, the extruded (and stretched) polypropylene layer is guided by guide rollers over a coating roll that rotates in the direction of travel opposite to the polypropylene layer. The coating roll is loaded with the aqueous dispersion and transfers the dispersion onto the polypropylene layer. As a result, the liquid dispersion can be applied particularly uniformly at very high processing speeds.

The solids content (PU particles, optionally nanoparticles and/or others) of the liquid dispersion can be 5 wt % to 20 wt %, or 10 wt % to 15 wt % (based on the total mass of the liquid dispersion). The wet layer formed by the liquid dispersion has, for example, a weight per unit area of 3 g/m² to 20 g/m², or of 6 g/m² to 10 g/m². To improve the wetting of the polypropylene layer with the dispersion, the polypropylene layer can be pre-treated with a wetting agent and/or the wetting agent can be admixed with the aqueous dispersion (content <0.5 wt %, or <0.3 wt %). A potential wetting agent is an ethoxylated acetylenic surfactant, such as is available under the trade name Surfynol® 440 from the company Evonik.

Moreover, the stretching in the machine direction (e.g. in a MDO apparatus) can occur at a temperature in the range from 90° C. to 120° C., or in the range from 95° C. to 112° C. The stretch ratio can be here in the range from 4 to 6, or in the range from 4.5 to 5. The stretching in the transverse direction (e.g. in a TDO apparatus) can occur at a temperature in the range from 140° C. to 190° C., or in the range from 150° C. to 185° C. The stretch ratio when stretching in the transverse direction can be in the range from 4 to 10, or in the range from 5 to 9, or in the range from 6 to 9.

The polypropylene film produced is typically a biaxially oriented polypropylene film. The line speed (production speed after the stretching) of the polypropylene film can be, for example, in the range from 40 m/min to 55 m/min or in the range from 45 m/min to 50 m/min (for test systems). The line speed in industrial production can be at least 300 m/min, or at least 400 m/min, or at least 500 m/min, or at least 600 m/min, or at least 700 m/min, or at least 800 m/min.

The coating can occur, for example, just on one side of the polypropylene layer, or on both sides. Moreover, the method can comprise a surface treatment of the side of the polypropylene layer opposite the coating, wherein the surface treatment particularly comprises a corona treatment and/or plasma treatment. As a result, the adhesion of the polypropylene film to the structural layers (e.g. a paper substrate) can be improved. Similarly, the printability and/or the metallizability can be improved.

The method also comprises the following steps:
metallization of the coating to arrange a metallization layer on the coating, wherein the metallization layer can comprise aluminium, silicon, copper, zinc, titanium, gold, silver, chromium as well as alloys and/or oxides of the aforementioned substances, and/or
laminating the polypropylene film on a structural layer (to obtain a laminate material), wherein the structural layer comprises a paper substrate or can comprise a paper substrate.

### BRIEF DESCRIPTION OF THE DRAWINGS

The disclosure is explained exemplarily in more detail in the following by means of the enclosed figures.

FIG. 1 shows a schematic structure of a polypropylene film according to an exemplary embodiment;

FIG. 2 shows a schematic structure of a laminate material according to an exemplary embodiment; and

FIG. 3 shows a schematic sequence of a production method.

### DETAILED DESCRIPTION

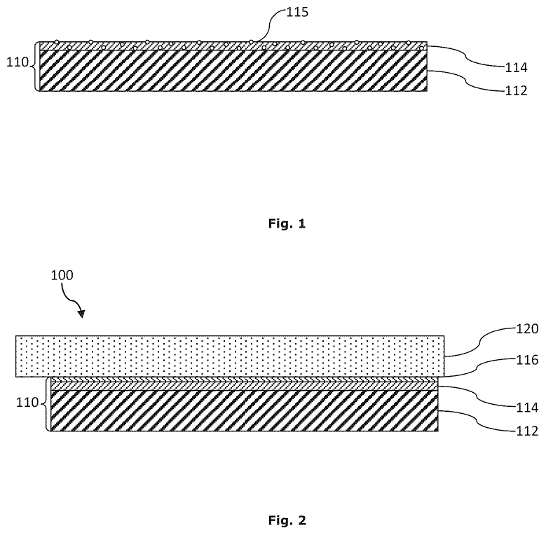

FIG. 1 shows a schematic structure of a polypropylene film 110 according to an exemplary embodiment. The thickness of the polypropylene film 110, the polypropylene layer 112 and the coating 114 as well as the size of the nanoparticles 115 is not reproduced true to scale.

The polypropylene film 110 is biaxially orientated and comprises a monolayer extruded polypropylene layer 112 as well as at least one coating 114. The coating 114 is arranged directly on the extruded polypropylene layer 112 in the shown example.

The polypropylene layer 112 comprises a homo polypropylene and a maleic anhydride grafted polypropylene. The homo polypropylene and the maleic anhydride grafted polypropylene have been extruded, for example, as a blend, wherein the content of the maleic anhydride grafted polypropylene can be at least 10 wt %, or at least 15 wt %, or at least 20 wt %.

The coating 114 is a dispersion coating that was applied as an aqueous dispersion on the extruded polypropylene layer 112. The coating 114 shown here comprises in addition to polyurethane (PU) also nanoparticles 115 (for example, SiO₂ nanoparticles). The dried coating 114 has a thickness in the range from 50 nm to 200 nm, or in the range from 80 nm to 180 nm, or in the range from 100 to 150 nm. The nanoparticles 115 have, for example, a mean particle diameter in the range from 20 nm to 150 nm, or in the range from 50 nm to 120 nm, or in the range from 80 to 100 nm. The nanoparticles result in the polypropylene film 110 having a roughness that prevents blocking of the polypropylene film 110 when being wound and unwound. The use of AB master batches in and on the polypropylene film 110 is not necessary.

The polypropylene film 110 shown here can have a thickness in the range from 2 μm to 10 μm, or in the range from 3 μm to 7 μm, or in the range from 4 to 6 μm. Thin polypropylene films with a thickness in the range from 2 μm to 6 μm are particularly preferred.

As is shown in FIG. 2, a metallization layer 116 can be arranged over the coating 114 of the polypropylene film 110. The metallization layer 116 can comprise aluminium, silicon, copper, zinc, titanium, gold, silver as well as alloys of the aforementioned substances. Similarly, the metallization layer can comprise oxides, in particular aluminium oxide (AlOₓ) and/or silicon oxide (SiOₓ). In particular for packaging applications, e.g. as a moisture barrier, metal layers of aluminium and aluminium alloys are particularly suitable. For application as a capacitor film, aluminium/zinc alloys can be used in particular.

In addition, the polypropylene film 110 (in metalized form or non-metalized form) can be applied to a structural layer 120 in order to obtain a laminate material 100.

The polypropylene film 110 can be orientated in such a way to the structural layer 120 that the metallization layer 116 faces in the direction of the structural layer 120 (as shown). In this case, the metallization layer 116 is arranged between the coating 114 and the structural layer 120. Alternatively (not shown), the metallization layer 116 can face away from the structural layer. If the polypropylene film 110 is not metalized, the coating 114 can face towards the structural layer, or face away from this.

If the polypropylene film 110 is applied to the structural layer 120 without the metallization layer 116, or if the metallization layer 116 faces away from the structural layer 120, the side of the polypropylene film 110, which is facing towards the structural layer 120 (and is not coated), can be surface treated (in particular with corona or plasma). The surface treatment can improve the adhesion of the polypropylene film 110 to the structural layer 120, for example a paper substrate.

In the shown example, the polypropylene film 110 can have a thickness in the range from 2 to 10 μm, in particular in the range from 2 μm to 6 μm, and the structural layer 120 can have a minimum thickness in the range from 40 μm to 200 μm, in particular in the range from 40 μm to 120 μm.

The ratio of the thickness of the polypropylene film 110 to the minimum thickness of the structural layer 120 can be selected in such a way that the content of the polypropylene film 110 in the laminate material 100 amounts to 5 wt % at the most, or 4 wt % at the most, or 3 wt % at the most.

The FIGS. 1 and 2 each show single-sided coated or single-sided metalized polypropylene layers 112. It is understood that polypropylene films 110 can also be obtained whose polypropylene layer 112 is coated on both sides and optionally is also metalized on both sides.

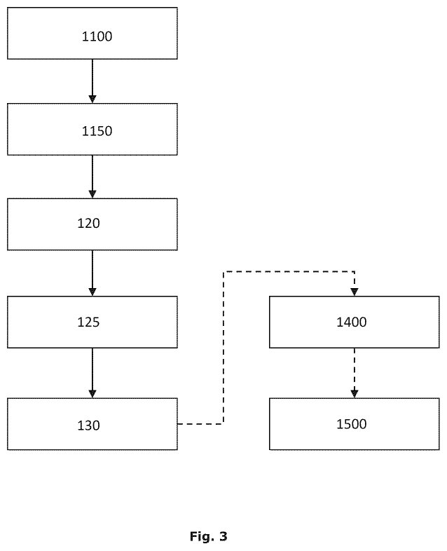

FIG. 3 shows a schematic sequence of a production method 1000 of a monolayer extruded polypropylene film 110 or a laminate material 100, such as shown in FIGS. 1 and 2.

The method 1000 comprises the extrusion 1100 of a polypropylene layer 112 (monolayer). The extruded polypropylene layer 112 comprises a homo polypropylene and a maleic anhydride grafted polypropylene, wherein these are preferably extruded as a blend.

After the extrusion 1100, the polypropylene layer 112 can be stretched (step 1150). The stretching 1150 can comprise, for example, stretching in the machine direction (e.g. in a MDO apparatus).

After the stretching 1150 in the machine direction, the polypropylene layer 112 is coated in step 1200 with an aqueous dispersion which comprises polyurethane and optionally nanoparticles. The coating 1200 occurs in particular inline (e.g. via reverse kiss coating). The polypropylene layer 112 can still be stretched optionally in the transverse direction (step 1250) after the coating 1200. After the drying of the aqueous dispersion, the coating 114 then exists on a biaxially orientated polymer film (see FIG. 1).

Alternatively, the coating can be applied before the stretching or after the stretching. In particular, the coating can be applied before a simultaneous stretching in the machine and transverse directions.

In a further step 1400, the coating 114 can be metalized to create a metal layer 116. In addition, the polypropylene film 110 can be laminated on a structural layer (step 1500) in order to obtain a laminate material.

### EXAMPLES

### Example #1

For the production of a film according to the invention (example #1), a blend comprising a homo polypropylene (here: Moplen HP 525J) and a maleic anhydride grafted polypropylene (here: ADMER™ AT1179E) was extruded as a monolayer. The content of the homo polypropylene amounted to approximately 90 wt % and the content of the maleic anhydride grafted polypropylene approximately 10 wt %.

The extrusion occurred via a slot die on a chill roll. The temperature of the twin-screw extruder used ranged from 240° C. to 260° C., the temperature of the chill roll at approximately 40° C. For further cooling, the extruded plastic melt was guided through a water bath whose temperature was in the range from 28° C. bis 32° C. Subsequently, machine and transverse stretching occurred with a machine stretching ratio in the range of 4-5. The line speed in the production of the biaxially orientated polypropylene film on a test plant was in the range from 45 m/min to 50 m/min. It resulted in a thickness of the polypropylene film of 6.1 μm (deviation±0.16 μm).

The usual scaling of the line speed of the test plant to industrial production allows a line speed in the industrial production of at least 300 m/min, or at least 400 m/min, or at least 500 m/min, or at least 600 m/min, or at least 700 m/min, or at least 800 m/min. The scaling factor (line speed_{industrial}/line speed_{test plant}) regularly amounts to 5 to 20.

The coating was applied inline onto the machine-stretched polypropylene layer (thus before transverse stretching) as a dispersion in the reverse kiss coating method. The dispersion comprised the polyurethane dispersion TAKELAC™ WPB-341 from Mitsui Chemicals as well as nanoparticles (Nouryon CT4-PL (5 wt % in the dispersion)).

The polypropylene layer was corona treated before the coating. The solids content in the PU dispersion amounted to 10-15%. This resulted in a dry layer thickness of the coating in a range from 100 nm to 150 nm.

The obtained polypropylene film is characterised by good optical properties (haze values: 0.86, according to ASTM D 1003) as well as by good friction properties (COF value: 0.67; according to DIN EN ISO 8295) so that blocking could be avoided. In addition, good adhesion of the coating onto the polypropylene layer could be achieved (what is termed the tape test was passed).

### Example #2

For the production of a film according to the invention (example #2), a blend comprising a homo polypropylene (here: Adstif HA 622 H) and a maleic anhydride grafted polypropylene (here: ADMER™ AT1179E) was also extruded as a monolayer. The content of the homo polypropylene amounted to approximately 80 wt % and the content of the maleic anhydride grafted polypropylene approximately 20 wt %.

The extrusion occurred via a slot die on a chill roll. The temperature of the twin-screw extruder used was in the range from 240° C. to 260° C., the temperature of the chill roll at approximately 40° C. For further cooling, the extruded plastic melt was guided through a water bath whose temperature was in the range from 25° C. bis 30° C. Subsequently, machine and transverse stretching occurred with a machine stretching ratio in the range of 4-5. The line speed in the production of the biaxially orientated polypropylene film was in a range of 50 m/min. It resulted in a thickness of the polypropylene film of 4.0 μm (deviation±0.10 μm).

The coating occurred as indicated in example #1.

The obtained polypropylene film is characterised by good optical properties (haze values: 0.90, according to ASTM D 1003) as well as by good friction properties (COF value: 0.95; according to DIN EN ISO 8295) so that blocking could be avoided.

The following table provides a summary of the examples (#1 und #2) according to the invention and the comparative examples (#3bis #6).

TABLE 1

| | | | | | | | HAZE | COF (μs) |
|---|---|---|---|---|---|---|---|---|
| | Film | Thickness | | | | Tape | ASTM D | DIN EN |
| Example | structure | [μm] | Coating | Homo PP | PP-g-MAH | Test | 1003 | ISO 8295 |
| # | mono- | 6 | yes | Moplen HP525J | ADMERAT1179E | (+) | 0.86 | 0.67 |
| 1 | layer | | (PU | | | | | |
| | PP | | dispersion) | | | | | |
| # | mono- | 4 | yes | AdstifHA622 H | ADMERAT1179E | (+) | 0.90 | 0.95 |
| 2 | layer | | (PU | | | | | |
| | PP | | dispersion) | | | | | |
| # | mono- | 6 | none | Moplen HP525J | ADMERAT1179E | not | 0.93 | 1.42 |
| 3 | layer | | | | | performed | | |
| | PP | | | | | | | |
| # | mono- | 4 | yes | Borealis | no | (−) | 0.79 | 0.76 |
| 4 | layer | | (PU | HC300BF | | | | |
| | PP | | dispersion) | | | | | |
| # | mono- | 4 | no | Boreallis | no | (−) | >2.0 | 0.75 |
| 5 | layer | | | HC300BF | | | | |
| | PP | | | | | | | |
| # | triple- | 8-18 | yes | | | (+) | 0.5 | 0.67 |
| 6 | layer | | | | | | | |
| | PP | | | | | | | |

### Comparative Example #3

The comparative example #3 is based on example #1. However, no coating was applied. It shows the friction values are increased considerably (COF (μs)=1.42) so that blocking could occur. The comparison of example #1 with the comparative example #3 also shows that the coating does not impair the optical properties.

### Comparative Example #4

In the comparative example #4, high-purity polypropylene (capacitor-grade PP-C, Borealis HC300BF) was extruded. Maleic anhydride grafted polypropylene was not admixed. The polypropylene layer obtained was then coated as in example #1. It shows that the production of thin films is possible, however, the adhesion of the coating and any metallizations are not sufficient. The tape test was not passed.

### Comparative Example #5

In the comparative example #5, high-purity polypropylene (capacitor-grade) was extruded. Maleic anhydride grafted polypropylene was not admixed, and the polypropylene layer was not coated. The film obtained had poor optical properties (Haze>2) and an applied metallization only adhered unsatisfactorily.

Comparative Example #6

According to comparative example #6, a triple-layer, thus multi-layer polypropylene film was extruded. The first layer comprises Moplen HP525J as well as Admer AT1179E. The second layer directly below this only comprises polypropylene (Moplen HP525J) and the third layer comprises polypropylene (Moplen HP525J) with an AB masterbatch. The film obtained was coated with a PU dispersion (as in example #1) In a first test, the film thickness could not be set below 18 μm. In a second test, 8 μm could then be achieved. However, the process parameters were unstable in the second test and the rate of production extremely low. Thinner films could not be produced.

As the examples and comparative examples show, the film according to the invention is producible economically and has excellent properties (blocking, friction and appearance, . . . ) and can thus overcome the disadvantages of the state of the art at least in part.

1. A coated, biaxially oriented polypropylene film, wherein the
polypropylene film is a monolayer extruded polypropylene film that comprises an extruded polypropylene layer as well as at least one coating, wherein
the extruded polypropylene layer comprises a homo polypropylene and a maleic anhydride grafted polypropylene, and wherein
the coating is a dispersion coating comprising polyurethane.

2. The polypropylene film according to claim 1, wherein the coating has a thickness in the range from 50 nm to 200 nm.

3. The polypropylene film according to claim 1, wherein the coating moreover comprises nanoparticles, wherein
the nanoparticles can have a mean particle diameter in the range from 20 nm to 150 nm.

4. The polypropylene film according to claim 1, wherein the extruded polypropylene film is made of homo polypropylene and maleic anhydride grafted polypropylene.

5. The polypropylene film according to claim 1, wherein the content of maleic anhydride grafted polypropylene in the extruded polypropylene layer can be at least 10 wt %.

6. The polypropylene film according to claim 1, wherein
the polypropylene film has a density in the range from 0.9 g/cm³ to 0.95 g/cm³, and/or wherein the polypropylene film has a thickness in the range from 2 μm to 10 μm.

7. The polypropylene film according to claim 6, wherein the thickness of the polypropylene film is in a tolerance range of a desired film thickness±0.4 μm.

8. The polypropylene film according to claim 1, wherein the coating is based on an aqueous dispersion coating.

9. The polypropylene film according to claim 1, wherein a metallization layer is arranged over the coating, wherein
the metallization layer (can comprise aluminum, zinc, titanium, gold, silver, silicon, copper and/or chromium as well as alloys and/or oxides of the aforementioned substances.

10. The polypropylene film according to claim 1, wherein
the coating is arranged on a first side of the polypropylene layer, and wherein a second, opposing side of the polypropylene layer is not coated, but is surface treated by means of a corona and/or plasma surface treatment.

11. A laminate material, comprising at least one polypropylene film according to claim 1, and a structural layer, wherein the polypropylene film is arranged on the structural layer.

12. The laminate material according to claim 11, wherein the structural layer comprises a paper substrate, or is made of a paper substrate.

13. The laminate material according to claim 11, wherein the content of polypropylene film in the laminate material amounts to 5 wt % at the most.

14. A method for producing a monolayer extruded polypropylene film according to claim 1, wherein the method comprises the following:
extrusion of a polypropylene layer, wherein the extruded polypropylene layer comprises a homo polypropylene and a maleic anhydride grafted polypropylene;
inline coating of the extruded polypropylene layer with a coating, wherein the coating is applied as an aqueous dispersion and comprises polyurethane;
stretching of the polypropylene layer, wherein the stretching comprises stretching of the polypropylene layer in the machine direction and/or stretching in the transverse direction, and wherein
the stretching occurs before and/or after the coating.

15. The method according to claim 14, wherein the produced polypropylene film is a biaxially oriented polypropylene film, wherein
a line speed in the production of the biaxially oriented polypropylene film is at least 300 m/min.

16. The method according to claim 14, wherein the extruded polypropylene layer is guided over a chill roll after the extrusion and before the stretching, wherein the temperature of the chill roll is in the range from 35° C. to 45° C., and wherein
the extruded polypropylene layer is guided optionally through a water bath, wherein the water bath has a temperature in the range from 20° C. to 35° C.

17. The method according to claim 14, wherein
the stretching in the machine direction occurs at a temperature in the range from 90° C. to 120° C., and/or wherein
the stretch ratio when stretching in the machine direction is in the range from 4 to 6.

18. The method according to claim 14, wherein
the stretching in the transverse direction occurs at a temperature in the range from 140° C. to 190° C., and/or wherein
the stretch ratio when stretching in the transverse direction can be in the range from 4 to 10.

19. The method according to claim 14, wherein the coating only occurs on one side of the polypropylene layer, and wherein the method furthermore comprises a
surface treatment of the side of the polypropylene layer opposite the coating, wherein the surface treatment particularly comprises a corona treatment and/or plasma treatment.

20. The method according to claim 14, wherein the method comprises furthermore at least one of the following steps:
Metallization of the coating to arrange a metallization layer on the coating, wherein the metallization layer can comprise aluminum, zinc, titanium, gold, silver, silicon, copper, chromium as well as alloys and/or oxides of the aforementioned substances, and/or
laminating of the polypropylene film on a structural layer, wherein the structural layer comprises a paper substrate, or can comprise a paper substrate.
